(19) United States
(12) Patent Application Publication
(10) Pub. No.: US 2015/0230564 A1
(43) Pub. Date: Aug. 20, 2015

(54) MOLD-IN CAST MALE SURFACE FASTENER AND METHOD FOR FABRICATION OF FOAM RESIN CAST BODY WITH MALE SURFACE FASTENER EMPLOYING SAME

(71) Applicant: KURARAY FASTENING CO., LTD., Osaka-shi, Osaka (JP)

(72) Inventors: Yoshikatsu Fujisawa, Fukui (JP); Shiro Ogawa, Osaka (JP)

(73) Assignee: KURARAY FASTENING CO., LTD., Osaka-shi, Osaka (JP)

(21) Appl. No.: 14/425,451

(22) PCT Filed: Aug. 16, 2013
(86) PCT No.: PCT/JP2013/004874

§ 371 Date: Mar. 3, 2015

(30) Foreign Application Priority Data
Sep. 3, 2012 (JP) 2012-192949

(51) Int. Cl. A44B 18/00; B60N 2/58; B29C 44/12

(52) U.S. Cl. CPC A44B 18/0076; B29C 44/1271; A44B 18/0061; A44B 18/0049; A44B 18/0069; B60N 2/58; B29K 2075/00

(57) ABSTRACT

The present invention relates to a mold-in cast male surface fastener wherein a water/oil repellent agent (5) is applied to a front surface of a tape-like substrate (1) on a front surface side of the surface fastener having a large number of male engagement elements (2) on the front surface of the substrate (1), and to the engagement elements (2) on the front surface.

### TECHNICAL FIELD

The present invention relates to a male surface fastener employed as a mold-in cast male surface fastener, which is embedded in the front surface of a cushion body (also referred to as “foam resin cast body,” hereinafter) when molding the cushion body to configure a seat for an automobile, vehicle, airplane, and various other chairs.

This type of cushion body with a male surface fastener has its front surface covered with a covering material such as cloth or leather having a female surface fastener attached to its rear surface. The covering material is fixed to the front surface of the cushion body by bringing the male surface fastener on the front surface of the cushion body into engagement with the female surface fastener, whereby the resultant cushion body is employed as a seat for an automobile, vehicle, airplane, and various other chairs.

### BACKGROUND ART

A seat that is employed in an automobile or any chairs is generally constructed by covering the front surface of a cushion body made of foam urethane or the like with a seat cover (covering material).

As a commonly used method for fabrication of a seat for an automobile and the like, there has been known a so-called mold-in formation method, a method for installing a tape-like surface fastener, which has a large number of engagement elements (normally, male engagement elements) on its front surface and embedded elements on its rear surface, in a predetermined position inside a molding die, inputting foam resin liquid to the molding die, foaming the foam resin liquid, and burying and integrating the embedded elements of the tape-like surface fastener in the cushion body in such a manner that the engagement elements are exposed to the outside of the front surface of the cushion body (see Patent Literature 1).

The rear surface of the seat cover is provided with female engagement elements (normally, loop-shaped engagement elements) capable of coming into engagement with the engagement elements of the foregoing male surface fastener. By bringing these engagement elements (so-called hooks and loops) into engagement with each other, the seat cover can be placed along the cushion body, covering and fixing the cushion body with the seat cover.

As illustrated in Patent Literature 1, in the mold-in formation method described above, in order to form a cushion body, the engagement element surface is mounted in the groove portion of the molding die for a cushion body, in such a manner that the engagement element surface is hidden therein, for the purpose of preventing the foam resin liquid for molding a cushion body from flowing into the male engagement element part of the male surface fastener. Thereafter, the foam resin liquid is poured into the molding die, and is then foamed and cured under a predetermined condition, thereby burying the rear surface of the surface fastener in the foamed body. After the surface fastener is securely adhered to the foamed body, the foamed body is removed from the molding die, thereby obtaining a cushion body with the engagement element surface of the surface fastener exposed.

However, when the foam resin liquid is poured into the molding die to which the surface fastener is being firmly attached, and when the foam resin liquid oozes out of the gap between the surface fastener and the groove portion of the molding die for some reason and flows into the engagement element part of the surface fastener, the engagement element surface of the surface fastener becomes covered with the foam resin, inhibiting the engagement elements from being exposed and resulting in inadequate engagement strength. Consequently, the resultant cushion body could become a defective product.

In the case of the currently known mold-in cast surface fastener, the foam resin liquid that flows into the engagement element part cannot easily be removed. In other words, the resin needs to be scraped off with a brush or the like using an organic solvent such as dichloromethane, or, when a large quantity of foam resin liquid flows into the engagement element part and the resin is difficult to be removed, such resin needs to be discarded. Either such removal or disposal of the resin liquid could lead to a cost increase, as well as increases in the workload and production time required for removal tasks and additional production.

In order to solve such problems, a mold-in cast surface fastener that can prevent the foam resin liquid from flowing into the engagement element surface is required.

As a way of preventing the foam resin liquid from flowing into the engagement element surface, Patent Literature 1, Patent Literature 2, Patent Literature 3 and the like each propose a general method for tightly attaching a surface fastener to a surface fastener groove portion that is provided in a molding die, and hiding the engagement element part between the groove portion and the rear surface of the fastener to separate the foam resin liquid from the engagement element part, thereby preventing the foam resin liquid from coming into contact with the engagement elements. Unfortunately, such a method is not enough to precisely prevent the foam resin liquid from flowing into the engagement element part. The users are constantly demanding an improvement in the method.

As a way of preventing the foam resin liquid from flowing into the engagement element surface, Patent Literature 4 also proposes a method for sticking a piece of cloth or a cover material made of elastomer resin or the like to the engagement element surface of the surface fastener. However, because the cover material is removed and discarded following the mold-in formation process, this method leads to an increase in the amount of waste, which is the disadvantage of this method. This method, therefore, cannot be recommended from environmental perspectives.

The present invention was contrived in order to solve these problems, and an object thereof is to provide a mold-in formation method using a mold-in cast surface fastener, which prevents foam resin liquid from flowing into an engagement element part of the surface fastener. The present invention, therefore, can solve the problem in which insufficient exposure of the engagement element surface of the surface fastener leads to a production of a defective seat cushion.

### CITATION LIST

### Patent Literature

Patent Literature 1: Japanese Patent No. 3128444

Patent Literature 2: Japanese Patent No. 4751015

Patent Literature 3: Japanese Unexamined Patent Publication No. 2006-341597

Patent Literature 4: Japanese Patent No. 3700727

### SUMMARY OF INVENTION

As a result of studying the specific means for solving the foregoing problems, the present inventors have discovered that the effect of preventing foam resin liquid from reaching an engagement element part of a mold-in cast male surface fastener can be exercised by employing, as a mold-in cast locking member, a mold-in cast male surface fastener wherein a water/oil repellent agent is applied to a front surface of a tape-like substrate on a front surface side of the surface fastener having a large number of male engagement elements on the front surface of the substrate, and to the engagement elements on the front surface. The inventors have also discovered that the foam resin can easily be peeled off of the engagement element surface even when the foam resin liquid oozes into the engagement element part.

### BRIEF DESCRIPTION OF DRAWINGS

FIG. 1 is a cross-sectional schematic diagram showing an example of a mold-in cast male surface fastener according to the present invention.

FIG. 2 is a cross-sectional schematic diagram showing another example of the mold-in cast male surface fastener according to the present invention.

FIG. 3 is a perspective schematic diagram showing an example of the mold-in cast male surface fastener according to the present invention.

FIG. 4 is a cross-sectional schematic diagram showing an example in which the mold-in cast male surface fastener of the present invention shown in FIG. 1 is attached to a groove portion of a die.

FIG. 5 is a cross-sectional schematic diagram showing another example in which the mold-in cast male surface fastener of the present invention shown in FIG. 2 is attached to a groove portion of a die.

FIG. 6 is a cross-sectional schematic diagram showing an example in which another example of the mold-in cast male surface fastener of the present invention is attached to a die for a mold surface fastener die.

FIG. 7 is a cross-sectional schematic diagram showing an example in which the mold-in cast male surface fastener shown in FIG. 1 is attached to a groove portion of a molding die and foam resin liquid is introduced thereto.

### DESCRIPTION OF EMBODIMENTS

An embodiment of the present invention is described next with reference to the drawings.

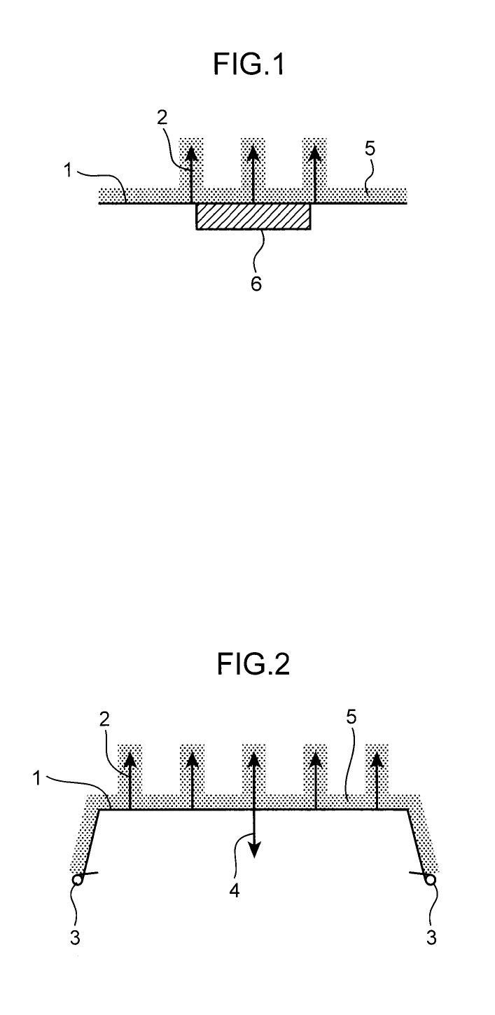

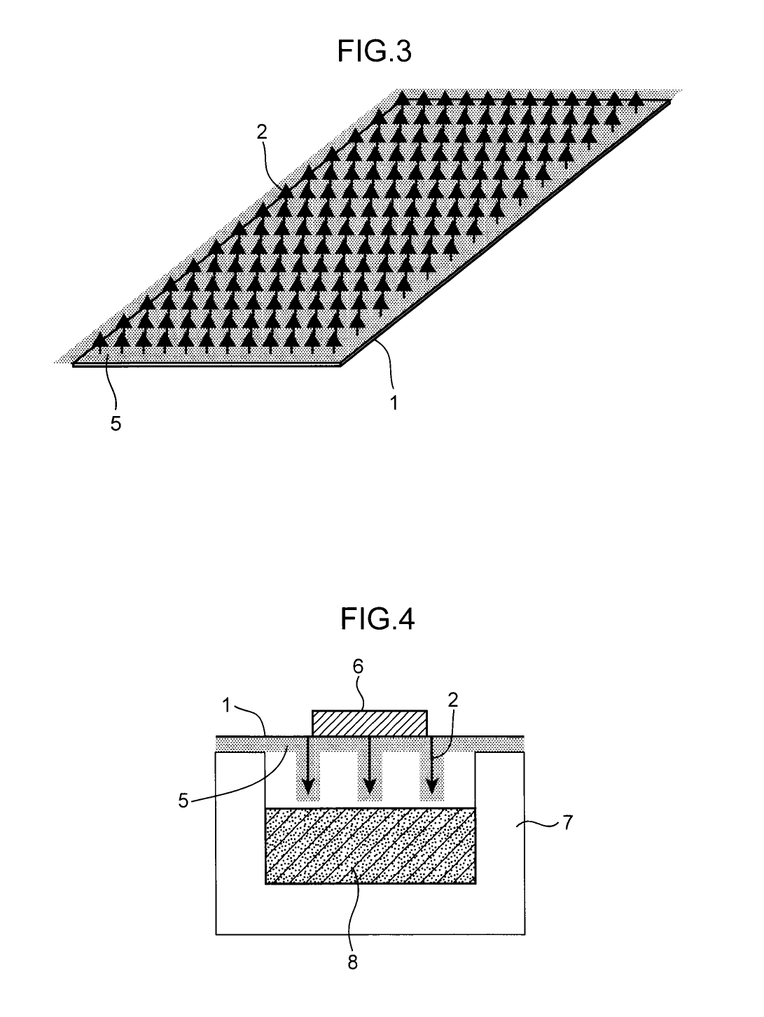

FIG. 1 is a cross-sectional schematic diagram showing an example of a mold-in cast male surface fastener according to the present invention. FIG. 2 is a cross-sectional schematic diagram showing another example of the mold-in cast male surface fastener according to the present invention. FIG. 3 is a perspective schematic diagram showing another example of the mold-in cast male surface fastener according to the present invention.

The reference numerals shown in the diagrams represent the followings.

1: Substrate, 2: Engagement elements, 3: Projections, 4: Embedded elements, 5: Water/oil repellency-treated surface, 6: Metal-containing layer, 7: Groove portion of die, 8: Magnet, 9: Molding die, 10: Foam resin liquid

In a mold-in cast male surface fastener of the present embodiment, the front surface of a substrate 1 has a large number of male engagement elements 2, and a water/oil repellency-treated surface 5 is formed by the application of a fluororesin-based or silicone-based water/oil repellent agent to the front surface of the substrate and to the engagement elements 2 formed on the front surface.

Due to the water/oil repellent agent applied to the front surface in which the large number of engagement elements exist, the male surface fastener of the present invention has the effect of preventing foam resin liquid from reaching the engagement element part, thereby inhibiting the engagement elements of the male surface fastener of the present invention from being buried in the foam resin.

In addition, owing to the water/oil repellent agent applied to the front surface in which the large number of engagement elements exist, the male surface fastener of the present invention cannot only prevent adhesion of the foam resin liquid to the engagement elements but also prevent the engagement elements from being buried completely in the foam resin liquid due to the capillarity of the water/oil repellent agent, even when the foam resin liquid reaches the engagement element part. Therefore, even in a case where the engagement elements are covered with the foam resin, the foam resin can easily be removed.

The male surface fastener according to the present invention can realize a stable process for manufacturing seat cushion bodies by means of a mold-in formation method, resulting in a decrease in the number of defects that can occur during the manufacture of seat cushion bodies, as well as the operation time and workload required to repair the defects or produce more seat cushion bodies. The male surface fastener according to the present invention can therefore achieve the effect of shortening the delivery period and reducing the costs and workload during the manufacture of seat cushion bodies.

The water/oil repellent agent is preferably fluororesin-based or silicone-based and is dried after application so that the resultant film has the hydrophobic group of the constituents of the water/oil repellent agent facing the outside of the coated surface. Preferred examples of the fluororesin-based water/oil repellent agent include repellent agents of oil type, emulsion type, and solution type. Preferred examples of the silicone-based water/oil repellent agent include repellent agents of oil type, emulsion type, and solution type. A fluororesin-based water/oil repellent agent of water solution type is more preferred. In some cases fluorine-based resin or silicon-based resin is used as a parting agent for the purpose of resin molding. However, due to their non-drying nature, these resins tend to inhibit adhesion between a male surface fastener and foam resin when adhering to an undesirable spot. Moreover, because the film does not form easily under a clement condition, these resins cannot provide water/oil repellency and are therefore not suitable for the water/oil repellent agent employed in the present embodiment.

The water/oil repellent agent employed in the present embodiment preferably has a surface tension of 10 to 30 dyne/cm or more preferably 11 to 20 dyne/cm. Also, the water/oil repellent agent preferably has a contact angle with water of 90 to 160 degrees.

Specific favorable examples of the water/oil repellent agent employed in the present embodiment include commercially available water/oil repellent agents such as NK Guard™ manufactured by Nicca Chemical Company and Fluorosurf™ manufactured by Fluoro Technology.

Specific examples of the methods for applying the water/oil repellent agent to the mold-in cast male surface fastener include a method for diluting resin solution of the water/oil repellent agent with a solvent or dispersant to approximately 1 to 25 times by weight in accordance with the engagement element surface of the surface fastener or the material of a foam resin cast body as well as for the purpose of viscosity adjustment so that the water/oil repellent agent can be applied stably, and then using the resultant diluted solution to adhere the mold-in cast male surface fastener in such a manner that only the engagement element surface is immersed in the solution or dispersion liquid, a method for spraying the same solution or dispersion liquid to the engagement element surface of the mold-in cast male surface fastener, and a method for applying the same solution or dispersion liquid to the engagement element surface of the mold-in cast male surface fastener with a brush or a brush roller. Especially the method that uses a brush or a brush roller is preferred because the water/oil repellent agent can be applied securely to the engagement elements 2 of the mold-in cast male surface fastener and the surface of the substrate 1, resulting in secure application of the water/oil repellent agent to the mold-in cast male surface fastener. The objects of the present embodiment can be accomplished by applying the water/oil repellent agent to the front surface of the substrate on the engagement element side and to the front surface of an engagement portion of the engagement elements. It is preferred that the front surface of the substrate on the engagement element side and the front surface of the engagement portion of the engagement element be covered with the water/oil repellent agent. However, in a case where even the surface on the rear surface side of the substrate is covered with the water/oil repellent agent, the foam resin cast body and the surface fastener cannot be adhered to each other strongly; therefore, it is preferred that the water/oil repellent agent not be applied to the rear surface side.

Moreover, for more preferable application, the substrate front surface on the front surface side of the mold-in cast male surface fastener and the front surface of the male engagement elements may be reformed by the execution of corona treatment, plasma treatment or the like prior to applying the water/oil repellent agent. The amount of the water/oil repellent agent to be applied is preferably about 0.1 to 10 g/m² in terms of solid content, or more preferably 0.5 to 5 g/m².

As shown in FIGS. 1 and 4, it is preferred that a widthwise central portion on the rear surface of the substrate 1 have a magnetic metal-containing layer 6 expanding in the lengthwise direction of the substrate, so that the mold-in cast male surface fastener of the present embodiment can securely be fitted into a groove portion of the die by means of a magnet 8 attached to the bottom 5 of the groove portion of the die, and then pushed against the bottom of the groove portion, precisely preventing the foam resin liquid from oozing out of the gap.

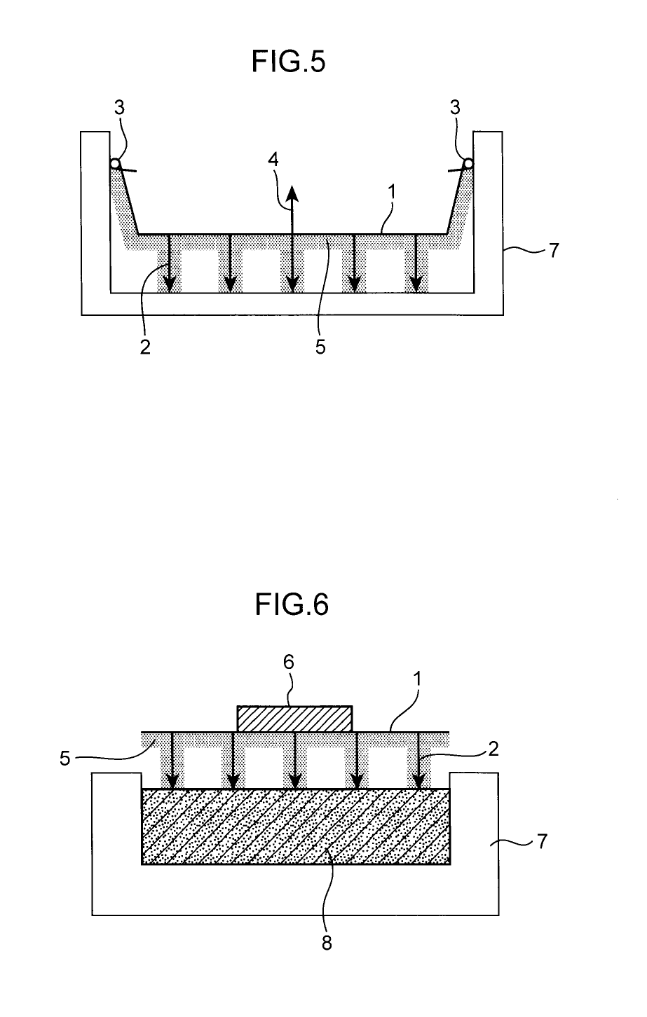

Moreover, as shown in FIGS. 2 and 5, it is also preferred that either widthwise end of the rear surface of the substrate 1 of the mold-in cast male surface fastener have a projection 3 that is provided upright on the rear surface, extends in the lengthwise direction of the substrate, and at least partially projects outward from the widthwise end of the substrate in the vicinity of a leading end. In this case as well, the projections can be brought into pressure-contact with a wall surface of the groove in the lengthwise direction by fitting the mold-in cast male surface fastener into the groove portion of the die, and consequently the gap between the groove portion and the mold-in cast male surface fastener can be closed, preventing the foam resin liquid from oozing out of the gap.

It is preferred that the rear surface side of the substrate 1 be provided with an embedded element 4 in order to achieve strong integration with a cushion body and the like. It should be noted that the projections 3 also function as embedded elements.

The width of the substrate 1 is preferably 5 to 25 mm or more preferably 10 to 15 mm, and the thickness of the same is preferably 0.1 to 1.0 mm or more preferably 0.3 to 0.7 mm.

The male engagement elements 2 may be in any known shape such as the shape of an arrowhead, a mushroom, and a key. In the present embodiment, such male engagement elements are generically referred to as male engagement elements or hooks. Especially, in the case of the male surface fastener in which the male engagement elements consist of stems rising from the front surface of the substrate and engagement protrusions that protrude in a tape width direction from the tips of the stems, and the engagement elements are arranged in lines along a tape lengthwise direction, such a male surface fastener is preferred because even when the foam resin liquid oozes into the engagement element surface, the foam resin can easily be removed from the engagement elements.

Among them, the arrowhead-shaped male engagement elements are preferred. In the present embodiment, arrowhead-shaped male surface fastener can bring about a greater effectiveness of the water/oil repellent treatment. More specifically, compared to, for example, mushroom-shaped hooks, the arrowhead-shaped male engagement elements can keep higher peel strength, enabling easy removal of foam resin (foam polyurethane resin or the like) when peeling the engagement elements off the foam resin, and bringing about an excellent advantage of having no resin remaining in the fastener.

The height of the engagement elements 2 (the height from the substrate surface) is not particularly limited but is preferably 1 to 5 mm or more preferably 1.5 to 2.5 mm. Also, the engagement element density is preferably 6 to 70 elements/cm² or more preferably 6 to 34 elements/cm².

So long as the engagement elements 2 consist of a stem rising substantially perpendicularly from the front surface of the substrate and an engagement protrusion protruding in the tape width direction and are arranged in lines in the tape lengthwise direction, the male surface fastener with such engagement elements is favorable for the present embodiment. In such a case, however, the number of engagement elements in a single line is preferably about 3 to 20 elements/cm, and, in terms of the engagement strength and the efficiency of removing the oozing, cured foam resin, it is preferred that 2 to 10 lines/cm or particularly 3 to 4 lines/cm of such lines exist in the width direction of the substrate 1.

In addition, it is preferred that the male engagement element density per unit area of the substrate be 6 to 70 elements/cm², that the distance between the stems of engagement elements adjacent to each other in the tape lengthwise direction be 0.4 to 5.0 mm, and that the distance between the engagement protrusions of engagement elements adjacent to each other in the tape width direction be 0.4 to 3.3 mm, so that the oozing, cured foam resin can be removed easily.

The distance between the stems of engagement elements adjacent to each other in the tape lengthwise direction means the distance between the midpoints of the heights of the engagement elements. The distance between the engagement protrusions of engagement elements adjacent to each other in the tape width direction means the distance from the tip of an engagement protrusion to the tip of another engagement protrusion of the nearest engagement element in the adjacent line.

When using the male surface fastener of the present embodiment as a locking member of the foam resin cast body, it is preferred that the embedded elements 4 be present on the rear surface of the substrate 1, so the male surface fastener can strongly be integrated with the foam resin cast body. It is preferred that one or more of the embedded elements 4 project outward in a direction that is substantially perpendicular or oblique with respect to the substrate 1, and that these embedded elements 4 each have a bulging portion in its intermediate portion or tip end portion, so that the male surface fastener cannot easily be peeled off of the foam resin cast body.

Moreover, as the embedded elements, a piece of cloth made of woven fabric, knitted fabric or non-woven fabric may be stuck to the rear surface of the substrate. Such cloth made of any of these fabrics can provide an anchoring effect when the foam resin liquid oozes at the time of mold-in formation and functions as a shielding member for preventing the foam resin liquid from oozing into the engagement element surface.

It is more preferred that the embedded elements 4 be present in a continuous manner along the lengthwise direction of the male surface fastener; however, the embedded elements 4 may be present in a discontinuous manner along the lengthwise direction of the male surface fastener, as with the engagement elements 2.

The dimensional factors of the embedded elements 4, such as the thickness, are determined according to the usage thereof, but normally, the height of protrusion of each embedded element is preferably 0.1 to 10 mm or more preferably 0.5 to 2 mm.

The height of the projection 3 standing at either widthwise end portion of the rear surface of the substrate 1 is preferably slightly shorter than the depth of the groove portion of the die. However, the height of each projection 3 that is slightly shorter than the depth of the groove is preferably, for example, 3 to 15 mm or more preferably 5 to 12 mm.

Examples of the resin employed for configuring the male surface fastener of the present embodiment include polyolefin-based resins such as polyethylene and polypropylene, polyester-based resins such as polyethylene terephthalate, polybutylene terephthalate and polylactic acid, polyamide-based resins such as nylon 6 and nylon 12, and various other thermoplastic resins. Especially the polyolefin-based resins are preferred in terms of moldability, and above all, polypropylene resins, polypropylene resins blended with a small amount of polyethylene, and polyamide-based resins such as nylon 6 and nylon 12 are preferred. In terms of affinity with foam resin for mold-in formation (usually polyurethane), mainly polyamide-based resins such as nylon 12 are most preferred.

Although not excellent in affinity with foam resin, when a polyolefin-based resin such as polypropylene is used as the constituent resin of the male surface fastener, it is preferred that the rear surface of the male surface fastener and the embedded elements consist of polyamide-based resin such as nylon 6 or nylon 12, which has excellent affinity. It is also preferred that the rear surface have a primer layer made of polyurethane-based resin or acrylic resin to improve its affinity with the foam resin. More preferably, the primer layer is made of acrylic resin.

The male surface fastener suitable for the present embodiment is formed by the use of a resin molding method such as extrusion or injection molding, but more preferably, the male surface fastener is formed by means of extrusion molding. Next is described a method for producing a male surface fastener by means of extrusion molding that is particularly suitable for the present embodiment.

First of all, from nozzles that have slits having the same cross-sectional shape as that of the surface fastener shown in FIGS. 1 and 2, a thermoplastic resin is melted and extruded into tapes, which are then cooled, to thereby obtain a tape-like product which has, on the front surface of a substrate, a plurality of lines of strips having a cross-sectional shape of the engagement elements that are arranged upright on the substrate in a continuous manner in the lengthwise direction, and which has, on the rear surface of the substrate, lines of strips having a cross-sectional shape of the embedded elements that are arranged in a continuous manner in the lengthwise direction.

Next, cuts are formed in each of the strips for engagement elements that are formed on the front surface of the tape-like product. These cuts are made at small intervals, starting from the tip of each strip to the root thereof in a direction crossing the lengthwise direction of the strips. It is preferred that the angle of the cuts be almost perpendicular to the lengthwise direction of the tape-like product so that the foam resin oozing into the engagement element surface can easily be removed. More preferably, the angle of the cuts is a right angle to as low as 60 degrees (i.e., 60 to 90 degrees with respect to the lengthwise direction). When the angle is approximately a right angle, the stems have a square or rectangular cross-sectional shape in a plane parallel to the substrate, but when the angle is not a right angle, the cross-sectional shape becomes a parallelogram. The parallelogram cross-sectional shape becomes sharper as the angle of the cuts shifts from the right angle. The interval of the cuts is preferably 1.0 to 5.0 mm and more particularly 1.0 to 2.0 mm.

Next, the tape-like product with cuts is stretched in the lengthwise direction. A stretching ratio that makes the length of the stretched tape-like product become approximately 1.3 to 3.5 times the original length of the tape-like product before stretching is employed. Stretching the tape-like product leads to expansion of the cuts on the strips, forming lines of a large number of male engagement elements with the independent strips. More preferably, the tape-like product is stretched at a stretching ratio of 1.6 to 2.5.

This method can provide a male surface fastener that has the large number of independent engagement elements 2 on the front surface and the embedded elements 4 on the rear surface. The embedded elements 4 may be arranged in a continuous manner in the tape lengthwise direction or in a discontinuous manner in the lengthwise direction as with the engagement elements.

Needless to say, if the embedded elements consist of cloth made of woven fabric, knitted fabric or non-woven fabric, the piece of cloth is stuck to the rear surface of the engagement member to configure the embedded elements. Examples of the method for sticking cloth include a method for sticking cloth by means of an adhesive or heat sealing.

FIGS. 4 to 6 are each a cross-sectional schematic diagram of an example in which the male surface fastener of the present embodiment is attached to a groove portion 7 of a die.

The die used in the present embodiment is preferably made of various inorganic materials such as aluminum, iron, stainless steel, and ceramic. Aluminum is preferred in terms of the workability of the die.

The cross-sectional shape of the groove portion can be changed into any shape depending on the size of the locking member but is not particularly limited. For a groove portion that is used for the male surface fastener of FIG. 1 that has the magnetic metal-containing layer 6, it is preferred that the magnet 8 be installed in the bottom 5 of the groove portion, as shown in FIG. 4. Also, for the male surface fastener of a shape shown in FIG. 2, it is preferred that the groove portion 7 has, as shown in FIG. 5, the shape of the bottom extending in the lengthwise direction, which is deep enough to fit therein the projections 3 extending in the lengthwise direction of the surface fastener and which is wide enough to prevent the foam resin liquid from oozing out of the gap between each projection and the groove wall surface. This type of groove portion is produced through casting, forging, carving, or other machining processes.

In the case of the groove portion shown in FIG. 4, the elongated portions that extend to either side from the engagement element surface 1 of the male surface fastener are placed on bank formed on widthwise upper wall surfaces of the groove portion, and the groove portion is made deep enough so that the engagement elements can fit completely in the groove. In this manner, the foam resin liquid can be prevented from oozing out of the gap. It is preferred that the width of the elongated portions extending to either side from the substrate of the male surface fastener be 5 to 12 mm. Furthermore, the elongated portions on the engagement element surface side may be provided with protrusions extending in the lengthwise direction, so that the elongated portions can be placed on and adhered easily to the banks of the widthwise upper wall surfaces of the groove portion of the die. These elongated portions are made of the same resin as the substrate when extrusion molding is executed to produce the male surface fastener. It is preferred that the water/oil repellent agent be applied to the inner surfaces of these elongated portions (i.e., the surfaces in which the engagement elements are present) in order to completely prevent entry of the foam resin liquid.

In the case of the groove shown in FIG. 5, the width between the inner walls is set to be substantially equal to or slightly wider than the width of the engagement element portion (effective width) of the male surface fastener of the present embodiment, as described above. A preferred width between the inner walls is 0.1 to 1.0 mm wider than the width of the engagement element portion. The projections 3, projecting beyond the engagement element portion to either side of the rear surface of the of the male surface fastener, eliminates the gap by coming into close contact with the inner walls of the groove portion, preventing the foam resin liquid from oozing into the engagement element surface. The width between the inner walls of the groove portion is set to be slightly narrower than or substantially equal to the entire width of the male surface fastener of the present embodiment or preferably 0.1 to 2.0 mm narrower than the entire width of the male surface fastener or more preferably 0.5 to 1.8 mm narrower than the entire width of the male surface fastener.

Moreover, it is preferred that the height of the inner walls rising at either end of the groove portion in the width direction be 5 to 35 mm from the bottom. Also, it is preferred that the width of the upper wall surfaces on either end of the groove portion in the width direction be 1.0 to 3.0 mm or more preferably 2.5 to 3.0 mm.

The groove portion shown in FIG. 6 is shallow, and there exists a gap between the substrate of the surface fastener and the upper surface of the groove in the width direction. In this case, the foam resin liquid oozes out of the gap. In the case of the male surface fastener of the present embodiment, however, the water/oil repellent agent applied to the front surface of the substrate can significantly prevent the foam resin liquid from oozing.

The male surface fastener is fitted into the groove portion in such a manner that the surface thereof with the engagement elements 2 faces the bottom surface of the groove portion. In so doing, in order to prevent the foam resin liquid from oozing into the engagement elements 2 at the time of the formation of the fastener, it is preferred that the engagement element portion be fitted completely in the groove portion and that the edges on either end in the width direction or the projections on the rear surface be brought into close and tight contact with the upper surface banks of either end of the groove portion or with the wall surfaces in the width direction of the groove portion, as shown in FIGS. 4 and 5. In order to prevent the foam resin liquid from oozing into the engagement element surface from the lengthwise ends of the engagement elements at the time of the formation of the fastener, it is preferred that even the flat part of the male surface fastener at its both ends in the lengthwise direction, where there are no engagement elements, be set so as to come into close and tight contact with the upper surface on both tips of the groove portion in the lengthwise direction.

In a case where the foam resin liquid is highly viscous, then the foam resin liquid is not likely to ooze into the engagement element; thus, sealing of these lengthwise end portions of the male surface fastener of the present embodiment does not need to be taken into consideration. However, in a case where the foam resin liquid has low viscosity and therefore easily oozes into the engagement elements, then it is preferred that the lengthwise ends on the bottom surface on the inside of the groove portion be provided with an appropriate size of dams in order to prevent the foam resin liquid from oozing in the dams. The width of each dam is preferably equal to or greater than the width of the upper portion of each inner wall of the die, and the height of each dam is preferably approximately equal to the height of the engagement elements or more preferably 1.5 to 2.5 mm.

It is also preferred that fiber masses or resin pieces be pated to either lengthwise end of the male surface fastener in the lengthwise direction to form seal portions so that the foam resin liquid can be prevented from oozing out of the lengthwise ends into the groove portion.

In the male surface fastener of the present embodiment shown in FIG. 1, the magnetic metal-containing layer is attached to the rear surface of the substrate. However, the magnetic metal-containing layer may be attached to the front or rear surface of the substrate or on the inside of the surface fastener. That magnetic metal-containing layer that is present on the rear surface of the substrate and protrude therefrom can function as the embedded elements.

A male surface fattener with such a magnetic metal-containing layer can be manufactured by, for example, applying adhesive-grade resin mixed with magnetic metal powder to the front and rear surfaces of the male surface fastener or forming the surface fastener itself with a resin containing magnetic metal powder. A preferred method is to apply adhesive-grade resin mixed with magnetic metal powder to the front and rear surfaces of the male surface fastener.

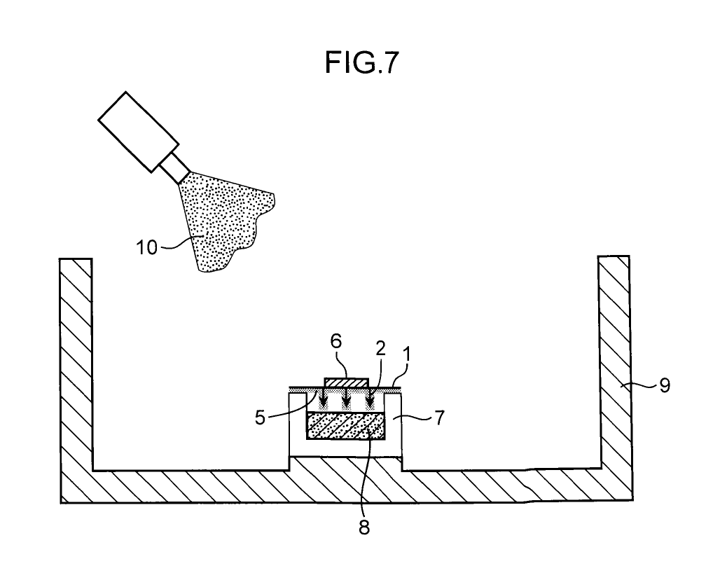

FIG. 7 is a cross-sectional schematic diagram showing an example in which the mold-in cast male surface fastener of the present embodiment is attached to the groove portion of the die. As shown in FIG. 7, the male surface fastener of the present embodiment is fixed to the groove portion fixed to the die, and then the foam resin liquid is introduced to the die. The introduced foam resin liquid oozes into ever part of the die while foaming and expanding and then becomes hardened, completing the formation process. Subsequently, the foamed cast body, which is a cushion body having the male surface fastener on its front surface, is removed from the die.

Foaming polyurethane-based resin is most preferred as the foam resin for molding, but not only this resin but also various resins can be employed.

The front surface of this foamed cast body is then covered with a covering material such as cloth or leather having a female surface fastener attached to its rear surface, and the male engagement elements on the front surface of the foamed cast body are brought into engagement with the female engagement elements attached to the rear surface of the cloth or the like. The front surface of the foamed cast body is then covered with cloth or leather, which is then fixated, thereby completing a seat for a vehicle such as an automobile, a train, and an airplane, or various other types of a seat or chair such as an office chair.

The present specification discloses various aspects of technology as described above, the primary technology of which is summarized below.

One aspect of the present invention is a mold-in cast male surface fastener wherein a water/oil repellent agent is applied to a front surface of a tape-like substrate on a front surface side of the surface fastener having a large number of male engagement elements on the front surface of the substrate, and to the engagement elements on the front surface. The use of this fastener as a mold-in cast engagement member not only provides the effect of preventing the foam resin liquid from reaching the engagement elements, but also enables peeling of the foam resin off the engagement element surface even when the foam resin liquid oozes into the engagement element section.

It is preferred that the male engagement elements of the mold-in cast male surface fastener be in the shape of an arrowhead. Such a configuration of the mold-in cast male surface fastener can improve the effectiveness of the water/oil repellent treatment described above.

In this mold-in cast male surface fastener, it is preferred that the rear surface of the substrate have a primer layer or resin layer excellent in affinity with a foam resin cast body or that the substrate consists of resin excellent in affinity with the foam resin cast body.

In this mold-in cast male surface fastener, it is preferred that the rear surface of the substrate have an embedded element rising therefrom. Such a configuration is considered to be able to integrate the fastener with a cushion body and the like.

In this mold-in cast male surface fastener, it is preferred that the male engagement elements consist of stems rising from the front surface of the substrate and engagement protrusions protruding from tip ends of the stems in a tape width direction, and the engagement elements be arranged in lines in a tape lengthwise direction. Such a configuration can provide an advantage of being able to easily remove the foam resin from the engagement elements even when the foam resin liquid oozes into the engagement element surface.

Moreover, in this mold-in cast male surface fastener, it is preferred that the male engagement element density per unit area of the substrate be 6 to 70 elements/cm², that the distance between the stems of the engagement elements adjacent to each other in the tape lengthwise direction be 0.4 to 5.0 mm, and that the distance between the engagement protrusions of the engagement elements adjacent to each other in the tape width direction be 1.1 to 3.3 mm. Such a configuration allows easily removing the oozing, cured foam resin.

Another aspect of the present invention is a method for fabrication of a foam resin cast body with a male surface fastener, and a foam resin cast body with a male surface fastener that is fabricated with this method. In the method, the aforementioned mold-in cast male surface fastener is fitted in a molding die that has a groove portion on an inner surface thereof for accommodating the male engagement elements, in such a manner that a male engagement element surface faces a bottom surface of the groove portion; then foam resin liquid is introduced to the molding die and is then foamed and cured to obtain a foam resin cast body with the male surface fastener; and subsequently the foam resin cast body with the male surface fastener is removed from the molding die.

Yet another aspect of the present invention is an invention of a vehicle seat in which the foam resin cast body with a male surface fastener described above is covered with a covering material such as cloth or fabric that has female engagement elements on its rear surface and the male engagement elements on the front surface of the foam resin cast body are in engagement with the female engagement elements.

The use of the male surface fastener according to the present invention can realize a stable process for manufacturing seat cushion bodies by means of a mold-in formation method, resulting in a decrease in the number of defects that can occur during the manufacture of the seat cushion bodies, as well as the operation time and workload required to repair the defects or produce more seat cushion bodies. The present invention can therefore achieve the effect of shortening the delivery period and reducing the costs and workload during the manufacture of the seat cushion bodies.

### EXAMPLES

Examples of the present invention are described hereinafter in more detail, but the present invention is not limited to these examples.

### Example 1

A roll of male molded surface fastener AP985 manufactured by Aplix International Inc. (made of nylon 12; the total width is 12 mm; the engagement effective width with bristles of engagement elements is 6 mm; the male engagement elements consist of stems rising from the front surface of the substrate and engagement protrusions (arrowhead-shaped) protruding from the tip ends of the stems in the tape width direction, are arranged in lines in the tape lengthwise direction, and have a height of 1.9 mm (the engagement element projections are cut at 70 degrees with respect to the lengthwise direction and stretched to 1.73 times to their original length); the engagement element density is 60 elements/cm² where the engagement elements are arranged in three lines; the distance between the stems of engagement elements adjacent to each other in the tape lengthwise direction is 0.7 mm; and the distance between the engagement protrusions of engagement elements adjacent to each other in the tape width direction is 1.2 mm), in which the rear surface of its substrate has a 4 mm-wide and 2 mm high magnetic metal-containing polyamide resin layer extending lengthwise, was used as a mold-in cast male surface fastener. See FIG. 1 for the cross-sectional shape of the fastener.

Next, the resultant male surface fastener was corona-treated at 0.7 kwh and 5 m/min for surface reformation, and then a water/oil repellent agent (NK Guard™ manufactured by Nicca Chemical Company; NDN-7E; surface tension: 15 dyne/cm), the concentration of which was adjusted to 10 wt %, was applied with a brush to the front surface of the substrate with the male engagement elements. The obtained fastener was let pass through and dried in a 90 to 100° C., 3.9 m hot air drying furnace at 5 m/min, resulting in the male surface fastener that had the water/oil repellent agent on the front surface of the substrate with a large number of engagement elements and the front surface of the male engagement elements but did not have the water/oil repellent agent at all on the rear surface. The fact that the engagement elements and the front surface of the substrate were treated with the water/oil repellent agent was confirmed based on the fact that these parts rarely got wet with water.

Thereafter, a step of resolving the tendency of curling of the roll applied with the water/oil repellent agent, a step of cutting the roll into a predetermined length, and a step of scraping (shaving) off the engagement elements on the lengthwise ends were executed sequentially, resulting in the male surface fastener that has a total length of 250 mm, a total width of 12 mm, a 6 mm engagement effective width with bristles of engagement elements, a 10 mm long flat part at each lengthwise end portion where the engagement elements were scraped off to expose the substrate, and a lengthwise polyamide resin-based metal-containing resin layer on the rear surface. The water/oil repellent agent was applied in an amount of 0.7 g/m² in terms of solid content.

The resultant male surface fastener with the water/oil repellent agent was fixed to the banks on the upper surfaces of the groove portion of the molding die having the groove portion on its inner surface for accommodating the male engagement elements and a magnet embedded in the bottom of the groove portion, the male surface fastener being fixed so that the engagement elements of the male surface fastener faced the bottom surface of the die, that the rear surface of the substrate with no engagement elements was flush with the upper surface of the molding die, and that there were no gaps between the die and the sections of the substrate on the front surface side of the male surface fastener where there are no engagement elements. Next, polyurethane-based foam resin liquid was introduced to the molding die, which was then foamed and cured to obtain a foam resin cast body with the male surface fastener. Then, the resultant foam resin cast body with a male surface fastener was removed from the molding die.

As a result of observing the resultant cast body, the area where the foam resin flowed as viewed from above was as extremely low as 10 mm² on average among sixteen cast bodies. In addition, the resin poured in was cured while keeping a contact angle with the engagement elements due to the effect of the water/oil repellent agent, and therefore did not easily get caught between the engagement elements. As a result, the foam resin that flowed in could easily be removed. After removing the foam resin that flowed into the engagement elements, the engagement element surface was rubbed hard for approximately five minutes. However, due to the excellent affinity between the nylon 12 configuring the surface fastener and the polyurethane configuring the foam resin, the rear surface of the surface fastener did not peel off of the foam resin.

The foam resin cast body with a male surface fastener that was obtained in this example is in the shape of a cushion of an automobile. Therefore, when a knitted fabric having female engagement elements on its rear surface was put on this cast body to bring the male engagement elements of the front surface of the foam resin cast body into engagement with the female engagement elements, the knitted fabric was fixed firmly to the front surface of the foam resin cast body. Accordingly, there is no problem with using this foam resin cast body as an automobile seat.

### Comparative Example 1

A foam resin cast body was obtained by the same method as the one used in Example 1, except that the water/oil repellent treatment executed in Example 1 was not executed in Comparative Example 1.

As a result of observing the resultant foam resin cast body, the area where the foam molding resin flowed when the surface fastener was viewed from above was 75 mm² on average among sixteen cast bodies, which was confirmed to be significantly greater than the amount of resin flowing in Example 1.

In addition, the foam molding resin that flowed into the engagement element surface was caught between the engagement elements and could not be removed easily.

### Example 2

A male surface fastener X6323-3 manufactured by Kuraray Fastening Company (made of polypropylene; the total width is 13 mm; the engagement effective width with bristles of engagement elements is 11 mm; the engagement elements have a height of 2.3 mm and are arranged in five lines; projections with bulging portions are formed on the tip ends that extend lengthwise from the widthwise ends of the rear surface; and an embedded element extends in the lengthwise direction in the middle of the rear surface. The tape-like engagement element projections are cut at a right angle with respect to the lengthwise direction and stretched to 1.53 times to their original length. The engagement element density is 60 elements/cm²; the distance between the stems of engagement elements in the tape lengthwise direction is 0.5 mm; the distance between the engagement protrusions of engagement elements adjacent to each other in the tape width direction is 0.8 mm; in which the male engagement elements consist of stems rising from the front surface of the substrate and engagement protrusions (arrowhead-shaped) protruding from the tip ends of the stems in the tape width direction, and are arranged in lines in the tape lengthwise direction, was used as a mold-in cast male surface fastener. See FIG. 2 for the cross-sectional shape of the fastener.

A water/oil repellent agent (NK Guard™ manufactured by Nicca Chemical Company; NDN-7E), the concentration of which was adjusted to 10 wt %, was applied with a brush to the front surface of the substrate having a large number of male engagement elements of this male surface fastener. The resultant fastener was dried in a 90 to 100° C. hot air drying furnace for 30 minutes, resulting in the male surface fastener that had the water/oil repellent agent on the front surface of the substrate with the large number of engagement elements. The water/oil repellent agent was applied in an amount of 0.7 g/m² in terms of solid content. The fact that the engagement elements and the front surface of the substrate were treated with the water/oil repellent agent was confirmed based on the fact that these parts rarely got wet with water.

The resultant cut product of the male surface fastener with the water/oil repellent agent was inserted into a groove portion that is provided on the inner surface of a molding die, is narrower than the male surface fastener, and is deep enough to fit the bulging portions of the projections of the rear surface of the male surface fastener, in such a manner that the engagement elements face the bottom surface of the groove portion and that the protrusions on the rear surface of the substrate push the inner wall surfaces of the groove portion so that no gaps are formed between the male surface fastener and the inner walls of the groove portion of the die. Subsequently, as in Example 1, polyurethane-based foam resin liquid was introduced, foamed, and cured to obtain a foam resin cast body with the male surface fastener. Next, this foam resin cast body with a male surface fastener was removed from the molding die.

As a result of observing the resultant cast body, the area where the foam molding resin flowed was as low as 55 mm² on average among sixteen cast bodies. In addition, the resin poured in was cured while keeping a contact angle with the engagement elements due to the effect of the water/oil repellent treatment, and therefore did not easily get caught between the engagement elements. As a result, the foam molding resin that flowed in could easily be removed.

The foam resin cast body with a male surface fastener that was obtained in this example is in the shape of a cushion of an automobile. Therefore, when a suede-like woven fabric having female engagement elements on its rear surface was put on this cast body to bring the male engagement elements of the front surface of the foam resin cast body into engagement with the female engagement elements, the woven fabric was fixed firmly to the front surface of the foam resin cast body. Thus, a seat that provides a luxurious feel can be obtained, and therefore there is no problem with using this foam resin cast body as an automobile seat.

### Comparative Example 2

A foam resin cast body was obtained by the same method as the one used in Example 2, except that the water/oil repellent treatment executed in Example 2 was not executed in Comparative Example 2.

As a result of observing the resultant foam resin cast body, the area where the foam molding resin flowed when the fastener was viewed from above was 160 mm² on average among sixteen cast bodies, which was confirmed to be significantly greater than the one obtained in Example 2.

In addition, the foam molding resin that flowed into the engagement element surface was caught between the engagement elements and could not be removed easily. In order to remove the foam resin caught between the engagement elements, the engagement element surface was rubbed hard a number of times. As a result, partial peeling occurred between the rear surface of the surface fastener and the foam resin cast body, making the surface fastener unusable as a cushion of an automobile.

### Example 3

A male surface fastener L6011 manufactured by Kuraray Fastening Company was obtained (made of polypropylene; the total width is 30 mm; the engagement effective width with bristles of engagement elements is 29 mm; (the engagement element projections are cut at a right angle with respect to the lengthwise direction and stretched to 1.48 times to their original length); the engagement element density per unit area of the substrate is 32 pieces/cm²; the engagement elements are arranged in twelve lines; the distance between the stems of engagement elements adjacent to each other in the lengthwise direction is 1.0 mm; the distance between the engagement protrusions of engagement elements adjacent to each other in the width direction is 2.0 mm; the male engagement elements consist of stems rising from the front surface of the substrate and engagement protrusions (arrowhead-shaped) protruding from the tip ends of the stems in the tape width direction, are arranged in lines in the tape lengthwise direction, and have a height of 1.8 mm. See FIG. 2 for the cross-sectional shape of the fastener. This male surface fastener was corona-treated for surface reformation and used as a mold-in surface fastener.

Next, a water/oil repellent agent (NK Guard™ manufactured by Nicca Chemical Company; NDN-7E), the concentration of which was adjusted to 10 wt %, was applied with a brush to the front surface of the substrate having the engagement elements of this male surface fastener. The resultant fastener was dried in a 90 to 100° C. hot air drying furnace for 30 minutes, resulting in the male surface fastener that had the water/oil repellent agent on the front surface of the substrate with a large number of engagement elements. The water/oil repellent agent was applied in an amount of 0.7 g/m² in terms of solid content. The fact that the engagement elements and the front surface of the substrate were treated with the water/oil repellent agent was confirmed based on the fact that these parts rarely got wet with water.

The resultant cut product of the male surface fastener with the water/oil repellent agent was stuck to the bottom surface of a molding die with double-sided tape, with the engagement element surface facing the bottom. Subsequently, as in Example 1, foam resin liquid was introduced to the molding die, which was then foamed and cured to obtain a foam resin cast body with the male surface fastener. Then, the resultant foam resin cast body with a male surface fastener was removed from the molding die.

As a result of observing the resultant foam resin cast body, the entire engagement element surface was buried due to the foam molding resin poured in. However, because the foam resin was cured while keeping a contact angle with the engagement elements due to the effect of the water/oil repellent treatment, and therefore did not easily get caught between the engagement elements. As a result, all the foam molding resin that flowed in could be removed relatively easily.

The foam resin cast body with a male surface fastener that was obtained in this example is in the shape of a cushion of an automobile. Therefore, when a knitted fabric having female engagement elements on its rear surface was put on this cast body to bring the male engagement elements of the front surface of the foam resin cast body into engagement with the female engagement elements after the foam resin that flowed into the engagement elements of the cast body was removed, the knitted fabric was fixed firmly to the front surface of the foam resin cast body. Accordingly, there is no problem with using this foam resin cast body as an automobile seat. Note that the rear surface of the surface fastener did not peel off of the foam resin cast body during the removal of the foam resin that covered the front surface of the engagement element surface.

### Example 4

In Example 3, a water/oil repellency-treated male surface fastener L-9011 manufactured by Kuraray Fastening Company was obtained (a cut product having an entire length of 300 mm; made of polypropylene; (the engagement element projections are cut at 70 degrees with respect to the lengthwise direction and stretched to 1.70 times to their original length); the engagement element density per unit area of the substrate is 35 pieces/cm²; the engagement elements are arranged in ten lines; the distance between the stems of engagement elements in the lengthwise direction is 0.9 mm; the distance between the engagement protrusions of engagement elements in the width direction is 1.0 mm; the male engagement elements consist of stems rising from the front surface of the substrate and engagement protrusions (arrowhead-shaped) protruding from the tip ends of the stems in the tape width direction, are arranged in lines in the tape lengthwise direction, and have a height of 1.4 mm. See FIG. 2 for the cross-sectional shape of the fastener. This male surface fastener was corona-treated for surface reformation.

Next, as in Example 3, this male surface fastener was stuck to the bottom surface of a molding die with double-sided tape, with the engagement element surface facing the bottom. Subsequently, foam resin liquid was introduced to the molding die, which was then foamed and cured to obtain a foam resin cast body with the male surface fastener. Then, the resultant foam resin cast body with a male surface fastener was removed from the molding die.

As a result of observing the resultant cast body, the entire engagement element surface was buried due to the foam molding resin poured in. However, the foam resin was cured while keeping a contact angle with the engagement elements due to the effect of the water/oil repellent treatment, and therefore did not easily get caught between the engagement elements. As a result, most of the foam molding resin that flowed in could be removed relatively easily. However, because some of the foam resin that flowed into the engagement element surface got caught between the engagement elements of the fastener, more effort was required to completely remove the foam molding resin compared to Example 3, causing part of the surface fastener to peel off of the foam resin cast body due to the rubbing process executed for the removal. Nonetheless, there was not a problem in using the surface fastener as an automobile seat.

As a result of forcibly and strongly rubbing the front surface of the foam molding resin covering the engagement element surface in order to remove the foam molding resin, peeling of part of the rear surface of the surface fastener off of the foam molding resin was discovered. In dealing with such phenomenon, acrylic resin, excellent in affinity with polyurethane resin, was applied, in an amount of 20 g/m² in terms of solid content, as a primer to the rear surface of a surface fastener prior to molding. As a result, peeling during the removal was not observed.

### Example 5

The effectiveness of the water/oil repellent treatment that was provided when the arrowhead-shaped male engagement elements were used was confirmed by confirming the impacts of hook-shaped engagement elements on the rate at which urethane foam flows into the surface fastener and the engagement strength, the impacts varying depending on the presence/absence of the water/oil repellent treatment.

A roll of male molded surface fastener, Magilock (L9011), manufactured by Kuraray Fastening Company in which is present (manufactured by Kuraray Fastening Company; the total width is 25 mm; the engagement effective width with bristles of engagement elements is 22 mm; the male engagement elements consist of stems rising from the front surface of the substrate and engagement protrusions (arrowhead-shaped, made of polypropylene) protruding from the tip ends of the stems in the tape width direction, are arranged in lines in the tape lengthwise direction, and have a height of 1.4 mm; (the engagement element projections are cut at 70 degrees with respect to the lengthwise direction and stretched to 3 times to their original length); the engagement element density is 35 pieces/cm²; the engagement elements are arranged in ten lines; the distance between the stems of engagement elements adjacent to each other in the tape lengthwise direction is 0.9 mm; the distance between the engagement protrusions of engagement elements adjacent to each other in the tape width direction is 1.0 mm;) was used as a mold-in cast male surface fastener.

Next, this male surface fastener was corona-treated at 0.7 kwh and 5 m/min for surface reformation, and then a water/oil repellent agent (NK Guard™ manufactured by Nicca Chemical Company; NDN-7E; surface tension: 15 dyne/cm), the concentration of which was adjusted to 10 wt %, was applied with a brush to the front surface of the substrate with the male engagement elements. The resultant fastener was let pass through and dried in a 90 to 100° C., 3.9 m hot air drying furnace at 5 m/min, resulting in the male surface fastener that had the water/oil repellent agent on the front surface of the substrate with a large number of engagement elements and the front surface of the male engagement elements but did not have the water/oil repellent agent at all on the rear surface. The amount of water/oil repellent agent applied was 0.7 g/m² in terms of solid content. The fact that the engagement elements and the front surface of the substrate were treated with the water/oil repellent agent was confirmed based on the fact that these parts rarely got wet with water.

Subsequently, this male surface fastener was stuck to a molding die with double-sided tape, with the engagement element surface facing the bottom of the molding die, as in Example 3. Thereafter, foam resin liquid was introduced to the molding die, which was then foamed and cured to obtain a foam resin cast body with the male surface fastener. Then, the resultant foam resin cast body with a male surface fastener was removed from the molding die.

Next, the urethane foam adhered to the engagement element surface was manually peeled off and removed from the resultant cast body, and an urethane foam residual rate (volume %) on the engagement element was measured. Note that the urethane foam residual rate was obtained by the following formula.

Urethane foam residual rate=Area of residue/Area of engagement element surface×100%

Note that this fastener was photographed from above. In the photograph, the area (two-dimensional) of the residual urethane foam was taken as the area of residue, and the area (two-dimensional) on a plane of the entire surface fastener as the area of engagement element surface. The results are shown in Table 1.

Subsequently, the resultant male molded surface fastener was pasted to a plastic board. As a female surface fastener to be brought into engagement with this male molded surface fastener, “Magic Loop EP2002” manufactured by Kuraray Fastening Company was used. These fasteners were stacked on top of each other, and the peel strength thereof was measured by means of an Autograph (AGS-100B, manufactured by Shimadzu Corporation), owned by Kuraray Fastening Company, under the conditions according to JIS-L-3416. The results are shown in Table 1.

### Comparative Example 3

A foam resin cast body was obtained by the same method as the one used in Example 5, except that the water/oil repellent treatment executed in Example 5 was not executed in Comparative Example 3.

With the resultant foam resin cast body, the urethane foam residual rate and peel strength were measured as in Example 5. The results are shown in Table 1.

### Example 6

A roll of male molded surface fastener, a mold-in fastener (AP225) manufactured by Aplix International Inc. in which is present (made of a woven fabric; the hooks are made of PP; the total width is 10 mm; the engagement effective width with bristles of engagement elements is 10 mm; the male engagement elements consist of stems rising from the front surface of the substrate and engagement protrusions (mushroom-shaped, polypropylene monofilament) protruding from the tip ends of the stems in the tape width direction, are arranged in lines in the tape lengthwise direction, and have a height of 1.0 mm; the engagement element density is 38 elements/cm²; the engagement elements are arranged in eight lines; the density of engagement elements adjacent to each other in the tape lengthwise direction is 2 pieces/4.2 mm (the elements being arranged in a continuous manner at distances of 1.6 mm/2.0 mm/1.6 mm); the distance between the engagement protrusions of engagement elements adjacent to each other in the tape width direction is 2.0 mm;) was used as a mold-in cast male surface fastener.

Next, this male surface fastener was corona-treated at 0.7 kwh and 5 m/min for surface reformation, and then a water/oil repellent agent (NK Guard™ manufactured by Nicca Chemical Company; NDN-7E; surface tension: 15 dyne/cm), the concentration of which was adjusted to 10 wt %, was applied with a brush to the front surface of the substrate with the male engagement elements. The resultant fastener was let pass through and dried in a 90 to 100° C., 3.9 m hot air drying furnace at 5 m/min, resulting in the male surface fastener that had the water/oil repellent agent on the front surface of the substrate with a large number of engagement elements and the front surface of the male engagement elements but did not have the water/oil repellent agent at all on the rear surface. The amount of water/oil repellent agent applied was 0.7 g/m² in terms of solid content. The fact that the engagement elements and the front surface of the substrate were treated with the water/oil repellent agent was confirmed based on the fact that these parts rarely got wet with water.

Subsequently, this male surface fastener was stuck to a molding die with double-sided tape, with the engagement element surface facing the bottom of the molding die, as in Example 3. Thereafter, foam resin liquid was introduced to the molding die, which was then foamed and cured to obtain a foam resin cast body with the male surface fastener. Then, the resultant foam resin cast body with male surface fastener was removed from the molding die.

With the resultant foam resin cast body, the urethane foam residual rate and peel strength were measured as in Example 5. The results are shown in Table 1.

### Comparative Example 4

A foam resin cast body was obtained by the same method as the one used in Example 6, except that the water/oil repellent treatment executed in Example 6 was not executed in Comparative Example 4.

With the resultant foam resin cast body, the urethane foam residual rate and peel strength were measured as in Example 5. The results are shown in Table 1.

TABLE 1

| | | Compar- | | Compar- |
|---|---|---|---|---|
| | Exam- | ative Ex- | Exam- | ative Ex- |
| | ple 5 | ample 3 | ple 6 | ample 4 |
| Product Number | L9011 | | AP225 | |
| Product Name | Magilock | | Mold-in fastener | |
| Shape of hooks | Arrowhead (PP | | Mushroom (PP mono- | |
| | molded article) | | filament/woven) | |
| Characteristics | Element density | | Element density | |
| | 35 elements/cm² | | 38 elements/cm² | |
| Urethane foam residual rate | 5% | 90% | 5% | 10% |
| Peel strength (kg/cm) | 0.8 | 0.8 | 0.4 | 0.7 |

The arrowhead-shaped surface fastener (Magilock; L9011) resulted in having the urethane foam removed easily while keeping its peel strength due to the water/oil repellent treatment executed thereon. On the other hand, the peel strength of the mushroom-shaped surface fastener (mold-in fastener; AP225) dropped as a result of the water/oil repellent treatment executed thereon. This shows that greater effects of the present invention can be exercised with the arrowhead-shaped surface fastener.

This application is based on Japanese Patent Application No. 2012-192949 filed on Sep. 3, 2012, the contents of which are hereby incorporated by reference into the present application.

Having described the present invention precisely and adequately by use of its embodiment with reference to the drawings, it should be recognized by those skilled in the art that the embodiment can readily be modified and/or improved. Therefore, as long as the modifications or improvements made by those skilled in the art do not depart from the scope of claims, such modifications or improvements should be construed as being included in the scope of claims.

### INDUSTRIAL APPLICABILITY

The present invention has a wide range of industrial applicability in the technical field relating to a male surface fastener and a method for fabrication of a cast body employing the same.

1. A mold-in cast male surface fastener,
wherein a water/oil repellent agent is applied to a front surface of a tape-like substrate on a front surface side of the mold-in cast male surface fastener having a large number of male engagement elements on the front surface of the substrate, and to the male engagement elements on the front surface.

2. The mold-in cast male surface fastener according to claim 1,
wherein the male engagement elements are in the shape of an arrowhead.

3. The mold-in cast male surface fastener according to claim 1,
wherein a primer layer or resin layer having an affinity with a foam resin cast body is present on a rear surface of the tape-like substrate, or
the tape-like substrate comprises resin having the affinity.

4. The mold-in cast male surface fastener according to claim 1,
wherein a rear surface of the substrate comprises an embedded element rising therefrom.

5. The mold-in cast male surface fastener according to claim 1,
wherein the male engagement elements comprise:
stems rising from the front surface of the tape-like substrate and
engagement protrusions protruding from tip ends of the stems in a tape width direction, and
the engagement elements are arranged in lines in a tape lengthwise direction.

6. The mold-in cast male surface fastener according to claim 5,
wherein a male engagement element density per unit area of the tape-like substrate is 6 to 70 elements/cm²,
a distance between the stems adjacent to each other in a tape lengthwise direction is 0.4 to 5.0 mm, and
a distance between the engagement protrusions adjacent to each other in a tape width direction is 1.1 to 3.3 mm.

7. A method for fabrication of a foam resin cast body with a male surface fastener, the method comprising:
fitting the mold-in cast male surface fastener according to claim 1 in a molding die that has a groove portion on an inner surface thereof for accommodating the male engagement elements, in such a manner that a male engagement element surface faces a bottom surface of the groove portion,
introducing foam resin liquid to the molding die,
foaming and curing the foaming resin liquid to obtain a foam resin cast body with the male surface fastener, and
removing the foam resin cast body with the male surface fastener from the molding die.

8. A foam resin cast body with a male surface fastener, which is obtained by the method according to claim 7.

9. A vehicle seat,
wherein the foam resin cast body according to claim 8 is covered with a covering material having female engagement elements on a rear surface thereof and made of cloth or leather, and
male engagement elements on a front surface of the foam resin cast body are engaged with the female engagement elements.
